(19) United States
(12) Patent Application Publication
(10) Pub. No.: US 2025/0355837 A1
(43) Pub. Date: Nov. 20, 2025

(54) DATA ACCESS PATTERN PROFILER FOR MEMORY COMPRESSION SCHEME SELECTION

(71) Applicant: Intel Corporation, Santa Clara, CA (US)

(72) Inventors: Stijn EYERMAN, Evergem (BE); Wim HEIRMAN, Aalter (BE); Vinodh GOPAL, Westborough, MA (US); Wajdi FEGHALI, Boston, MA (US)

(21) Appl. No.: 19/289,997

(22) Filed: Aug. 4, 2025

(51) Int. Cl. G06F 16/174; G06F 21/55

(52) U.S. Cl. CPC G06F 16/1744; G06F 21/552

(57) ABSTRACT

Methods and apparatus for data access pattern profiler for memory compression scheme selection are described herein. Respective data are stored as uncompressed data and compressed data in the system memory in which data are stored using multiple compressions schemes using different chunk sizes. In conjunction with servicing memory Read request from the compressed data, access patterns are profiled to generate profiled access patterns that are used to determine compression schemes to use to selectively recompress portions of the compressed data. Virtual memory areas are allocated for storing compressible data structures and divided into compressed memory regions (cmrs). Access to sampled pages in the cmr are profiled to generate the profiled access pattern for the cmr, which is used to determine whether a cmr compression scheme should be changed and what scheme to use for recompression.

### CROSS-REFERENCE TO RELATED APPLICATIONS

This application contains subject matter that is related to subject matter disclosed in U.S. patent application Ser. No. 19/049,751 filed Feb. 10, 2025, entitled OS-TRANSPARENT MEMORY DECOMPRESSION WITH HARDWARE ACCELERATION and U.S. patent application Ser. No. 19/255,057, filed Jun. 30, 2025, entitled VARIABLE CHUNK SIZE MEMORY COMPRESSION.

### BACKGROUND INFORMATION

Memory cost is a growing part of total cost of ownership, due to slow advancements in memory technology and applications with larger memory footprints (e.g., big data and artificial intelligence (AI)). Memory compression increases the usable memory capacity without requiring more physical memory and it can also increase the effective memory bandwidth by transferring compressed memory blocks through the memory channel. However, it also incurs a potential performance penalty because data needs to be decompressed before it can be used by the processor cores. A challenge in memory compression is to compress when advantageous while limiting the performance penalty.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram of an architecture illustrating selective components of the OS transparent decompression scheme, according to one embodiment;

FIG. 2 is a diagram of a CPT entry and its fields, according to one embodiment;

FIG. 3a is a diagram illustrating an example of a compression scheme employing 128 B chunks, according to one embodiment;

FIG. 3b is a diagram illustrating an example of a compression scheme employing 256 B chunks, according to one embodiment;

FIG. 3c is a diagram illustrating an example of a compression scheme employing 512 B chunks, according to one embodiment;

FIG. 3d is a diagram illustrating an example of a compression scheme employing 1024 B chunks, according to one embodiment;

FIG. 3e is a diagram illustrating an example of a compression scheme employing 2048 B chunks, according to one embodiment;

FIG. 3f is a diagram illustrating an example of a compression scheme employing a 4 KB chunk, according to one embodiment;

FIG. 4 is a diagram illustrating a compressed page table (CPT), according to one embodiment;

FIG. 5a is a diagram illustrating the organization of a CPT cache line, according to one embodiment;

FIG. 5b is a diagram illustrating the organization of a profiled/sampled CPT cache line, according to one embodiment;

FIG. 6 is a diagram illustrating how cmrs and the physical address to cmr mapping works, according to one embodiment;

FIG. 7 is a flowchart illustrating operations depicted in FIG. 6 used to access data in the compressed partition and generate and implement profiled access patterns;

FIG. 8 is a flowchart illustrating operations and logic performed for a Read request to access data, according to one embodiment;

FIG. 9 is a schematic diagram illustrated selected hardware components of an exemplary computing platform, according to one embodiment;

FIG. 10 is schematic diagram illustrating an SoC implementing a memory coherency architecture employed by the embodiment of FIG. 9, according to one embodiment;

FIG. 11 is a diagram illustrating how addresses, tags and indices are handled, according to one embodiment; and

FIG. 12 is schematic diagram illustrating a system including a System-on-Package (SoP) having circuitry configured to implement aspects of the embodiments disclosed herein.

### DETAILED DESCRIPTION

Embodiments of methods and apparatus for a data access pattern profiler for memory compression scheme selection are described herein. In the following description, numerous specific details are set forth to provide a thorough understanding of embodiments. One skilled in the relevant art will recognize, however, that the teachings disclosed herein can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

With quickly growing data set sizes (e.g., large databases, large AI models, etc.), memory has become an important component of performance, energy and cost. Compressed memory enables storing more data on the same memory capacity, reducing the memory cost and saving energy by storing and moving data in compressed format. However, it comes with a performance overhead, because data needs to be decompressed before it can be used. To address these issues, some recent and future processors, such as Intel® Xeon® and client systems include compression accelerators (In-Memory Analytics Accelerator (IAA)) that significantly reduce the (de) compression latency versus software (de) compression.

Because accessing compressed memory requires an additional decompression operation, it cannot follow the conventional memory access hardware flow that is implemented in current processors. Therefore, current commercial memory compression implementations (e.g., ZSWAP and ZRAM) use page faults and the operating system (OS) to support memory compression. Data in compressed space is not mapped in the page table (PT), generating a page fault interrupt to the OS when accessed. The OS then looks up the compressed data, performs the decompression (either in software or hardware) and maps the decompressed page to the page table. It also puts the decompressed page in plain (decompressed) DRAM, where it can be accessed in the future without decompression overhead.

Under this scheme there is some reserved space in plain DRAM to store compressed pages. To ensure enough space, the OS regularly scans pages in plain DRAM, and compresses cold pages (that are not recently touched, and thus unlikely to be touched soon) to move to compressed DRAM, leaving space for future decompressions. Ideally, this is done in the background, with no overhead for the running application. However, if the OS is unable to free space quickly enough, and no space is left to put the decompressed page of the current access, it first needs to migrate another page to compressed space, further increasing the latency of accessing compressed data.

Whether or not data should be compressed and what compression scheme (compression algorithm, compression chunk size) is optimal to limit the performance penalty depends on how the data of a certain data structure is accessed. Infrequently accessed data (cold data) can tolerate a large decompression latency and thus slow, highly compressed schemes, while frequently accessed hot data preferably should be decompressed more quickly or not be compressed at all. High spatial locality access patterns (e.g., a sequential streaming pattern) can benefit from larger compressed chunks, since all data will be needed anyways, and larger chunks enable higher compression ratios. Sparsely accessed data should use small chunks, because decompressing large chunks takes more time and most of the data is not needed. It is therefore important to choose the right scheme for each data structure.

In accordance with aspects of the embodiments disclosed herein, a data access pattern profiler is provided that can assist the OS in deciding which compression scheme to use for respective data structures to achieve improved compression while limiting the performance impact. In one aspect, the data access pattern profile comprises a combined software (OS) and hardware solution and does not require user or compiler hints.

Under the embodiments, the operating system is responsible for deciding what data to compress and what compression scheme to use. An online monitoring scheme is used to provide hints to the OS. Additionally, hot data can be stored compressed and can be decompressed with low overhead (e.g., without incurring a page fault). The proposed monitoring hardware may be included in a hardware decompression accelerator, monitoring decompressions to record access patterns.

Under the embodiments, data can be compressed and decompressed using different schemes, balancing compression ratio and decompression speed. In particular, we consider the chunk size as the main parameter, where small chunks have low decompression latency but also low compression ratio, and large chunks (e.g., up to a full page) have a higher compression ratio but also a higher decompression latency. The compression algorithm can also depend on the chunk size.

Main memory is divided into an uncompressed and a compressed partition. The OS (or the user) can set the sizes of these partitions. The OS can decide to migrate data (per page) between these partitions. It can also change the compression scheme of a certain data structure if the benefit of the new scheme is higher than the overhead of recompressing the data. The OS has a periodic page scanning phase where it records which pages are recently accessed. Pages that have not been accessed during a certain time (e.g., 2 minutes) are assumed to be cold and are candidates to get swapped out when low on memory. We piggyback on this page scanning phase to also check access patterns and potentially (re) compress certain memory pages.

To implement the transparent decompression and pattern detection scheme, a new address space and translation table is defined.

### Compressed Address Space

At a first level, memory pages are mapped to page tables (PT) using virtual address spaces. To enable access to compressed data, we define a new address space, the compressed physical (PHYS_C) space. It contains addresses to compressed data as if these data were not compressed: a byte address maps to a byte in the uncompressed data. Because the data is in fact compressed, these addresses do not directly point to actual locations on the DRAM device, but they are used by the cores to request data from the compressed memory space.

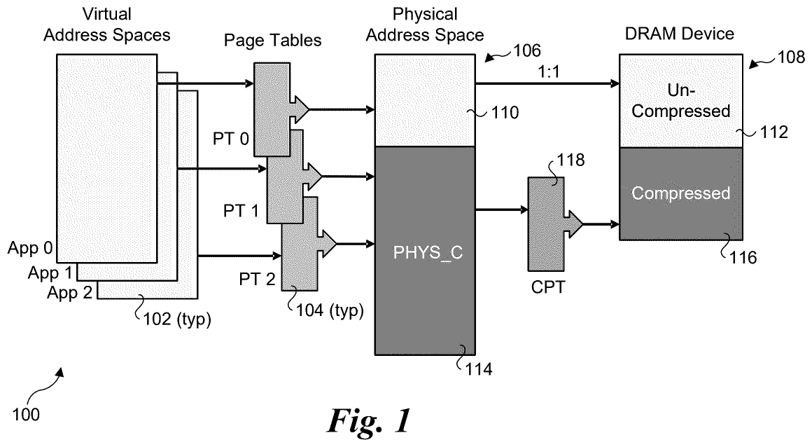

FIG. 1 shows an architecture 100 illustrating selective components of the OS transparent decompression scheme, according to one embodiment. Architecture 100 includes virtual address spaces 102, page tables 104, a physical address space 106, and a DRAM device 108. There is a virtual address space 102 per process, which uses its page table to translate to physical addresses in physical address space 106. As illustrated three virtual address spaces 102 are depicted for respective processes (e.g., applications), labeled App 0, App 1, and App 3, observing that in practice an application may have multiple processes, each of which would be allocated a separate virtual address space. Each of these virtual address spaces will be mapped to pages in physical address space 106 using respective page tables 104, labeled PT 0, PT 1, and PT 2.

The physical address space 106 of a processor that supports transparent decompression is split into two distinct partitions indexed by the most significant (MS) bits of the physical address. The first partition is conventional physical address space 110, i.e., the addresses map directly to a location in uncompressed memory 112 on DRAM device 108, also referred to as “plain” DRAM. The second partition is the PHYS_C space 114, which requires another translation to locate compressed data 116 on memory device 108 and a decompression to obtain the data of the cache line that the core is requesting. We call this secondary translation level the compressed page table (CPT) 118.

The CPT is maintained by the OS, and in one embodiment is stored on a fixed location in memory with a fixed organization, similar to conventional PTs. This enables a hardware CPT walker to translate PHYS_C addresses to the location of the compressed page in memory, similar to the hardware PT walker that is common in current processors.

### Decompression Scheme

Address space setup: A user (or hypervisor) needs to configure how much memory space is reserved for plain DRAM and for compressed DRAM; in one embodiment this configuration is performed at boot time. The plain DRAM partition determines the conventional physical address space. The exact compressed physical space size is not known beforehand, because we do not know the compression factor of the data that will be allocated. This is not an issue, because PHYS_C addresses do not point to actual device locations and the OS can assign PHYS_C addresses as long as there is space in the compressed partition.

Allocation & migration: The OS is still responsible for allocating and migrating data to the plain or compressed DRAM space. When allocating/migrating a page to compressed space, the OS generates a PHYS_C address in the compressed physical space, adds the PHYS_C to the conventional PT with a read-only flag, compresses the page (using software or a hardware accelerator), allocates the compressed page to compressed memory and adds the PHYS_C to device address in the CPT.

Read request: When a core issues a read request to the compressed partition, the virtual address is first translated to the PHYS_C address using conventional PT (and TLBs). If the requested cache line is cached on-chip (local cache or shared L3 or last level cache (LLC)), it is fetched from cache like an uncompressed access.

Decompression only needs to be done when the request misses in all cache levels. In that case, the request reaches the memory controller (MC), where it is detected that it belongs to the compressed partition (using the MS bits of the physical address).

### Hardware Additions

A version of the CPT is already maintained by the OS in the conventional schemes, but is not in a fixed standard format on a fixed address in memory. There is only one CPT across the system, compared to one PT per process, as shown in FIG. 1 and discussed above. In one embodiment the CPT is indexed using indexes derived from PHYS_C addresses, which has a smaller address space than the virtual address space. Furthermore, PHYS_C addresses are assigned by the OS, which can be made consecutively to densely fill the CPT. The CPT is therefore significantly less complex than the PT and may be implemented as a single table in some embodiments.

In one embodiment specialized decompressors are implemented in hardware close to the MCs for transparent decompression in addition to existing hardware supporting conventional compression/decompression (such as IAAs) for OS-directed compressions and decompressions. Part of the CPT can also be cached on-chip to speed up the translations, similar to the conventional TLBs. An important difference is that this cache should be kept only at the MCs (or otherwise not part of the CPU core). In some embodiments, the cache is embedded in the memory controller, while in other embodiments the cache is located proximate to the memory controller. In other embodiments, decompression is performed by software.

The decompression scheme also requires software changes in the OS. The operating system needs to implement the concept of PHYS_C addresses, add them in the PT and maintain the CPT. Compressed pages should be marked as such in the PT, such that a write to a compressed page generates a page fault. (The R/W bit cannot be reused for this purpose because there might be read-only data in compressed space that should cause an actual access violation exception when written to). The page fault handler should correctly interpret writes to compressed space events, e.g., turning them into page migrations. Background migration processes may still be supported, but preferably be adapted to the new scheme, e.g., less aggressively demoting pages and moving write-intensive and beyond-cache reuse pages to plain DRAM.

To compress more data, the decompress latency should be reduced to enable frequent access to compressed data with a limited performance impact. Decompress latency can be reduced by compressing data in smaller chunks. For example, a 4 KB page can be compressed in four 1-KB chunks. To access a specific cache line, only 1 of the 4 chunks needs to be decompressed, reducing the decompress latency by ˜4×. If the full page eventually needs to be decompressed (e.g., the full page migrates to uncompressed memory), the chunk with the earliest needed data (the cache line requested by a core) can be decompressed first, serving that request earlier than when decompressing the full 4 KB page in one chunk.

However, smaller chunk sizes have a downside: the smaller the chunk size, the smaller the compression ratio is. Larger chunks have more chances of finding repeating patterns that can be encoded in fewer bits, and their metadata overhead is spread across a larger chunk. Smaller chunks for improving performance reduce the capacity savings, balancing performance and cost.

The performance-cost balance, determining the chunk size, is different for different data access frequencies and patterns. Cold memory, i.e., data that is not accessed frequently (in the current phase of the application), is not sensitive to latency and therefore large chunks are preferable to save as much capacity as possible. Hot memory requires small chunks, because adding latency directly impacts performance. Hot data with locality, i.e., neighboring data is accessed soon after, can spread the decompress latency across multiple requests: if all 16 64 B cache lines in a 1 KB chunk are eventually needed, the average decompress latency per request is only 1/16 of the chunk decompress latency. Therefore, they can tolerate larger chunk sizes, saving more capacity.

An application typically has multiple data structures, each with different access characteristics. It is therefore beneficial to support multiple chunk sizes, each tailored to a specific data structure's characteristics. This flexibility enables the maximum capacity savings with limited performance impact.

### Support for Flexible Compression Chunk Sizes

The embodiments disclosed below describe the infrastructure needed to natively support multiple compression chunk sizes to find the best balance between capacity savings and performance impact. It can be used in the context of high-speed transparent decompression, as described in U.S. patent application Ser. No. 19/049,751 (OS-TRANSPARENT MEMORY DECOMPRESSION WITH HARDWARE ACCELERATION). The embodiments focus on storing and retrieving compressed data for decompression in an efficient way. The following aspects outside the scope of this disclosure, and thus not covered and assumed to be existing:

Compression and decompression algorithms and methods: the optimal (de) compression algorithm could depend on the chunk size. We assume that the available software and/or hardware is capable of (de) compressing data using different chunk sizes. The variable chunk size (de) compression schemes disclosed herein are independent of whether decompression is implemented in software or hardware, and of the hardware/software techniques to initiate a decompression (page fault or transparent decompression).

Memory access pattern profiling may be used to determine cold and hot data, and whether or not data has locality, and thus which chunk size is optimal for which data structure. In some embodiments, it is up to the OS, the compiler and/or the programmer to make that decision.

One challenge is to retrieve compressed data based on a request from a core or cache that contains the uncompressed address of the data, i.e., the address the data would have if it was not compressed. The size of the compressed chunk depends on the contents of the chunk: an all-zero chunk can easily be compressed in a single byte, while a perfectly uniformly and independently distributed sequence of 0s and Is might turn out to be uncompressible. To support maximal capacity savings, in one embodiment all compressed chunks are stored back-to-back, meaning that there is no analytical way to determine the location of the compressed chunk out of the uncompressed address. This is addressed by maintaining a list of mappings between the uncompressed address and the compressed chunk location (similar to the page tables for translating virtual addresses to physical addresses). Each chunk requires its own mapping, i.e., an entry in the list.

The following is assumed for the embodiments disclosed herein:

Data is compressed in page size entities, e.g., a given page either includes at least some compressed data or all data for the page are uncompressed. A page containing at least some compressed data is referred to as a compressed page (observing a portion of a compressed page may contain one or more chunks of uncompressed data). The compression decision is made by the OS, which tracks memory in pages. Whether or not a page is compressed can be tracked in the page table, or by partitioning the physical address space into an uncompressed and a compressed partition, which means the physical address determines if it is compressed or not. Within a compressed page, data can be compressed in multiple chunks that may be the same or differ; the largest possible chunk size is a page (4 KB in most cases), while the smallest chunk size can be up to one 64 B(Byte) cache line.

Compressed chunks are aligned to 64 B addresses, meaning that each chunk starts at a 64 B boundary. Generally, 64 B is the access granularity of DRAM memory, and this alignment ensures that a compressed chunk can be fetched without any overlaps with other chunks (because they end/start on the previous/next 64 B boundary). Furthermore, it also enables storing addresses in 64 B multiples, meaning that we don't need to store the lower 6 bits of the address. Since the minimum compressed chunk size is 64 B, the uncompressed chunk size needs to be larger than 64 B to have capacity savings. This also means that the last few bytes of a compressed chunk up to the next 64 B boundary might be unused if the compressed chunk size is not a multiple of 64 B, slightly reducing the capacity savings compared to the theoretic optimum.

The list to translate uncompressed memory addresses to compressed chunk locations are stored in the CPT. The following provides details regarding how to store compressed data and how to organize the CPT such that it is limited in size (to reduce its memory overhead) and such that it is fast and simple to look up the location of the compressed data.

The smaller the chunk size, the more chunks are needed to cover a certain compressed memory capacity, potentially significantly increasing the size of the CPT. Therefore, we propose to make the CPT size independent of chunk size. Because data is compressed in pages, we propose to have one CPT entry per page, making CPT indexing also independent of the chunk size: it is indexed by the page address. The CPT can be organized as a single direct-mapped table, indexed by adding the physical page identifier to the CPT base address. If there are large unused blocks (‘holes’) in the physical address space, a direct-mapped table might not be memory storage efficient. In that case, a multilevel table is more appropriate, similar to the conventional multilevel virtual to physical page tables (where there are large holes in the virtual address space).

In one embodiment a CPT entry encodes the chunk size and the locations and sizes of each compressed chunk in the page. The sizes are needed to determine the number of 64-B requests to the memory controllers to fetch the compressed chunk from memory. It is assumed that all chunks in a page are compressed using the same (uncompressed) chunk size, assuming that the data in a page likely belongs to the same data structure with the same access pattern.

In the embodiments shown and described herein the size of a CPT entry is fixed, enabling simple bit operations on the address to locate a CPT entry. One embodiment employs 64-bit (8 B) CPT entries, matching the logical unit of a 64-bit processor, but different sizes are possible depending on the supported chunk sizes.

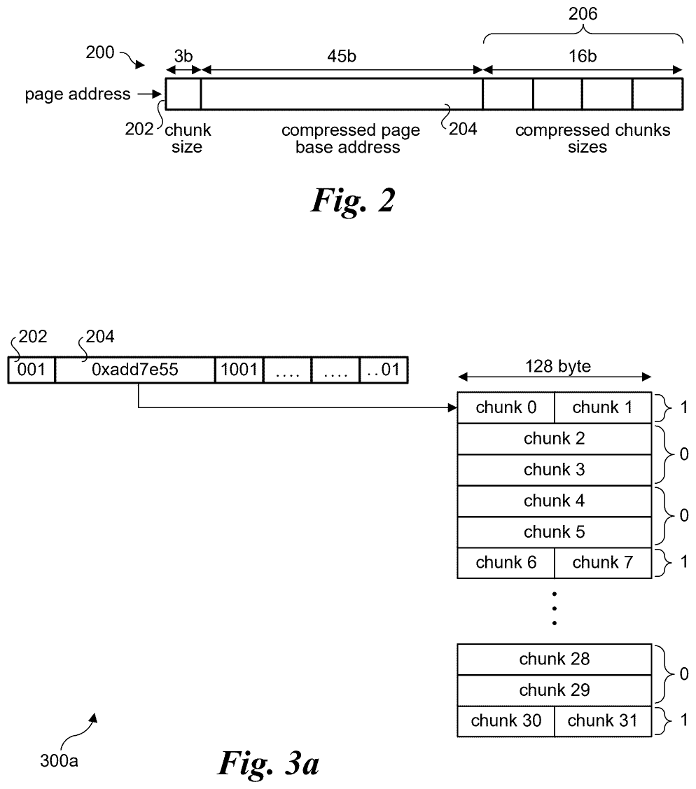

FIG. 2 shows a CPT entry 200 and its fields, according to one embodiment. In general, a CPT entry contains an encoded chunk size (field) 202 encoding the chunk size, a compressed page base address 204 and one or multiple fields 206 denoting the sizes of each compressed chunk. The first chunk is located at the base address, the second at the base address plus the size of the first, etc. All addresses and sizes are in multiples of 64 B; they should be shifted 6 bits to the left to calculate the actual byte address. Using 45 bits for the address means that we can allocate up to 2 PB of data in the compressed partition (45 bits+6 bits=51 bits). This range can be extended by adding a first level table that contains the first (few) address bit(s) to append in front of the base address.

Under one embodiment, 6 chunk sizes are supported and an invalid identifier is used to support compressed memory systems that require checking the validity/presence of a compressed page. 3 bits are used to represent 8 states. The supported chunk sizes with the 3-bit mode are:
000: invalid
001:128 B chunks
010:256 B chunks
011:512 B chunks
100:1024 B chunks
101:2048 B chunks
110:4096 B chunks
111: no compression

A 64 B chunk size is not supported, because that would lead to <64 B compressed chunks and we assume a minimum DRAM transfer size of 64 B, so transferring <64 B would not provide any bandwidth benefit. The minimum size of a compressed chunk is 64 B, and all compressed chunks are a multiple of 64 B (with possibly a few bytes unused).

In one embodiment 16 bits (or less) are used to indicate the compressed chunk sizes. These bits are defined based on the chunk size:

For 128 B chunks, either compression into 64 B (or less) or no compression is supported. Each 128 B chunk is either mapped onto a 64 B compressed chunk or a 128 B uncompressed chunk. To encode this in the 16-bit field, we pair the 32 128 B chunks (to make a 4 KB page) into 16 pairs. Each pair is either compressed into two 64 B chunks or not compressed into two 128 B chunks, indicated by a 1 or 0 in the 16-bit compressed chunk size field. This means that if one of the two 128 B chunks in a pair is not compressible to at most 64 B, the whole pair is stored uncompressed. Only when both are compressible, they are stored compressed.

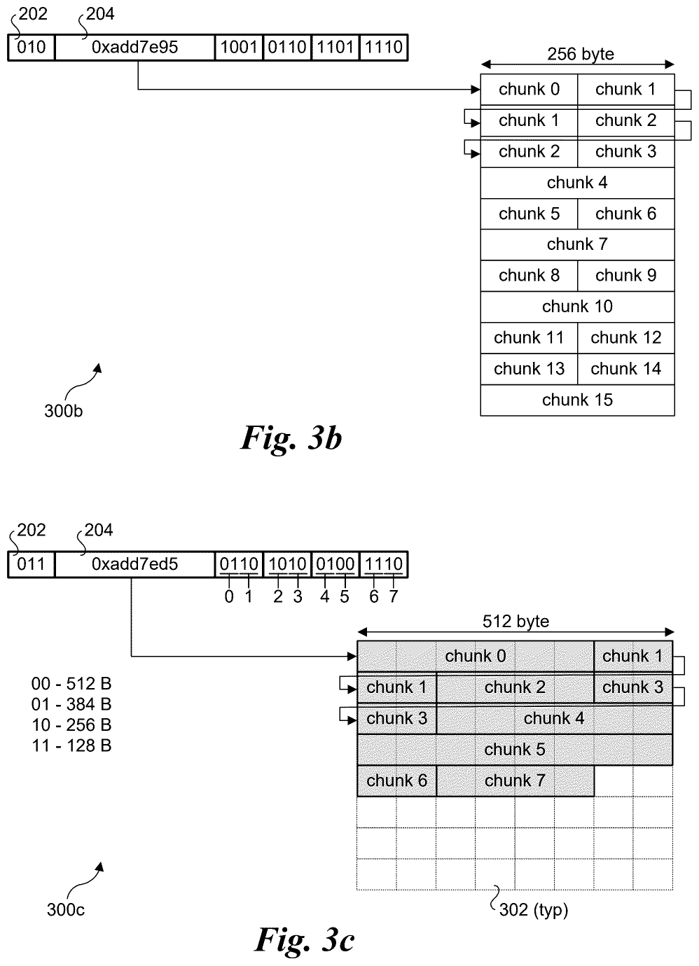

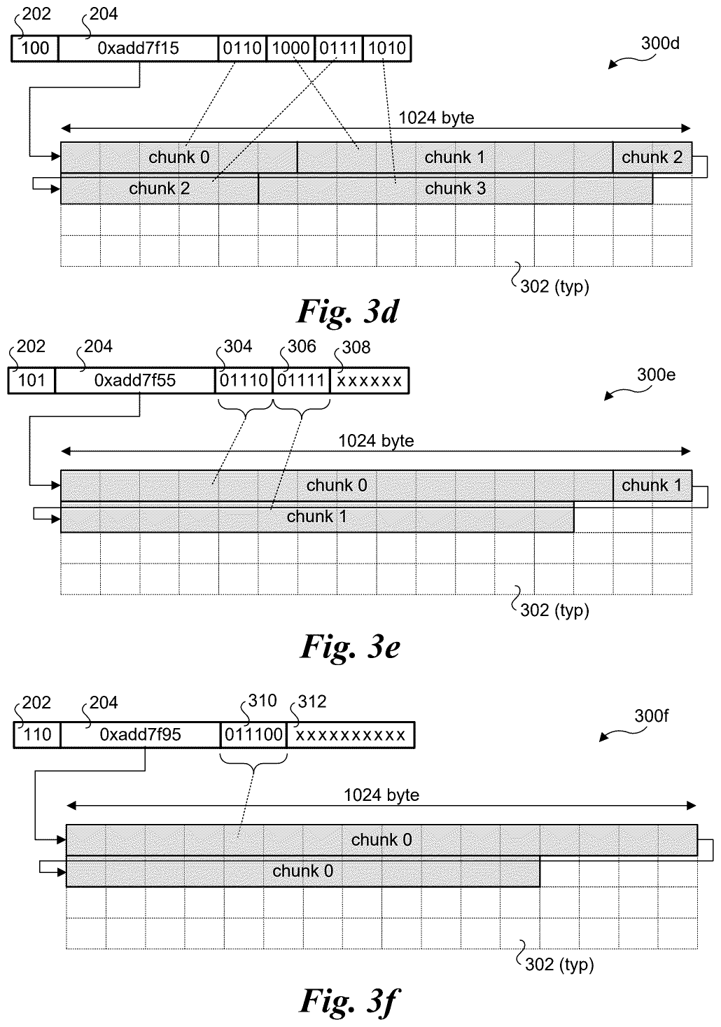

FIG. 3a shows a diagram 300a illustrating an example of a compression scheme employing 128 B chunks. The location of the compressed chunk can be found by adding 64 B for each compressed chunk and 128 B for each uncompressed chunk of the preceding chunks to the base address. For example, considering the first 4-bit size field and 8 chunks, 1001 means that 128 B chunk 0 is stored compressed in 64 B at offset 0, chunk 1 is compressed at offset 64, chunk 2 is uncompressed at offset 128, chunk 3 is uncompressed at offset 256, chunk 4 is uncompressed at offset 384, chunk 5 uncompressed at offset 512, chunk 6 compressed at offset 640 and chunk 7 compressed at offset 704. The effective compression ratio for these first 8 chunks is 8*128 B/(4*64 B+4 * 128 B)=1.33. For uncompressed chunks, the requested 64 B cache line can be directly sent to the core. For compressed chunks, the 64 B compressed chunk is first sent to the decompressor and decompressed into a 128 B chunk, after which the requested cache line is sent to the core.

As shown in diagram 300b in FIG. 3b, a similar scheme is used for 256 B chunks. The chunks are either compressed into 128 B compressed chunks or not compressed. There are 16 256 B chunks in a page (labeled chunk 0, chunk 1, . . . chunk 15 in diagram 300b), so we can now indicate for each chunk whether it is compressed or not using one bit in the 16-bit compressed chunk size field.

Chunks can be found by either adding 128 B or 256 B to the base address. For the example 4-bit 1001 field, chunk 0 is compressed at offset 0, chunk 1 uncompressed at offset 128, chunk 2 uncompressed at offset 384 and chunk 3 compressed at offset 640. A similar pattern applies to the remaining 12 chunks (chunks 4-15), as defined by 4-bit fields 0110, 1101, and 1110. The compression ratio for the entire page is 16*256 B/(10*128B+6*256 B)=1.45.

128 B chunks and 256 B chunks have the same maximum compression ratio of 2 in this scheme. The advantage of using 256 B chunks is that more chunks will be compressible to 128 B than there are 128 B chunks compressible to 64 B.

FIG. 3c shows a diagram 300c illustrating an example of a compression scheme employing 512 B chunks. There are 8 512 B chunks in a 4 KB page, so we have 2 bits per chunk in the 16-bit field. These can be used to encode 4 compressed chunk sizes, e.g., 128 B (compression factor 4), 256 B (compression factor 2), 384 B (compression factor 1.33) or 512 B (no compression). This example graphically shows the level of compression for the page, which includes sixty-four 64 B cache lines 302 (when uncompressed). The aggregate size occupied by the eight chunks 0-7 is 38*64 B=2432 B. The compression ratio is 4096/2432 =1.68.

FIG. 3d shows a diagram 300d illustrating an example of a compression scheme employing 1024 B chunks. For 1024 B chunks, we can encode all compressed chunk sizes from 1 64 B cache line to 16 64 B cache lines (no compression) in the four 4-bit subfields of the 16-bit field. In this example, chunk 0 is encoded as 0110b (=6 decimal), chunk 1 is encoded as 1000b (=8 decimal), chunk 2 is encoded as 0111b (=7 decimal), and chunk 3 is encoded as 1010b (=10 decimal). The compression ratio=4096/(31*64)=2.06.

FIG. 3e shows a diagram 300e illustrating an example of a compression scheme employing 2048 B chunks. For 2048 B chunks, we only need two 5-bit fields 304 and 306 to encode all 1 to 32 cache line compressed chunk sizes. In this example, chunk 0 is encoded as 01110b (=14 decimal) and chunk 1 is encoded as 01111b (=15 decimal). The compression ratio is 4096/(29*64)=2.21. As further shown, the remaining 6 bits 308 are marked ‘x’ to indicate they are ignored.

FIG. 3f shows a diagram 300f illustrating an example of a compression scheme employing a 4096 B (4 KB) chunk. For full page 4 KB chunks, we need 6 bits to encode its size in multiples of 64 B, which are stored in a 6-bit field 310, with the remaining 10 bits 312 marked ‘x’ to indicate they are ignored. In this example, 6-bit field 308 contains 011100b (=28 decimal). The compression ratio is (4096/28*64)=2.29.

For uncompressed pages (chunk size mode 111), the compressed chunk sizes field is not used. Uncompressed pages can be used for pages that do not meet a certain level of compression (e.g., more than half of the chunks are uncompressible). For these pages, the capacity and bandwidth gains of compression are low, while the lookup and decompression latency overhead (for the compressed chunks) is still there.

Having many different chunk sizes allows the OS/hypervisor or programmer to select the optimal size for each application and data structure. In general, the higher the locality, the larger the chunk size can be, because that increases the compression factor (capacity and bandwidth gains) while diffusing the decompression latency across multiple requests from the cores to the same chunk. Low-locality data structures benefit from smaller chunks, limiting the decompression latency.

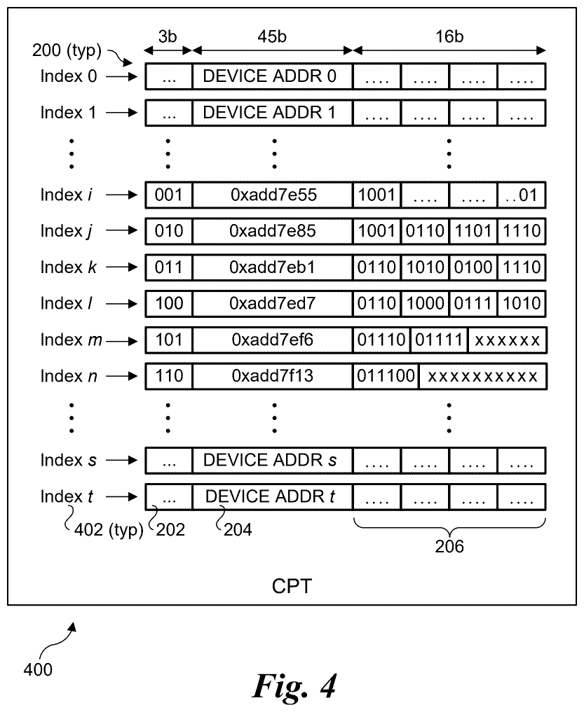

FIG. 4 shows a CPT 400, according to one embodiment. CPT 400 includes a plurality of CPT entries 200 having the same fields as CPT entry 200 shown in FIG. 2 and discussed above. Each CPT entry has an index 402. In one embodiment, PHYS_C addresses are assigned consecutively (which is determined by the OS memory allocator) and a function is used to calculate the index of the CPT entry belonging to a PHYS_C page. For example, if the compressed partition starts at address A_C, the CPT entry index can be found by taking (PHYS_C-A_C)/4096, e.g., subtract the partition start from the PHYS_C address and integer divide by 4K to transform to “page units.”. The CPT should be large enough to hold all compressed pages.

If PHYS_C pages are not assigned consecutively, this indexing might create “holes” in the CPT, which makes it less efficient in terms of memory usage. In this case, there can be a “PHYS_C” tag in the CPT itself to tighten the holes, in combination with a hash function to avoid walking over all CPT entries. In an alternative embodiment, this approach is used.

The device address is used to locate the memory controller, DRAM chip, DIMM, bank, etc., by using parts of the address to index these structures. In one embodiment, after the compressed chunk is located using the CPT, the decompression engine sends multiple 64B data fetch requests to the memory subsystem to fetch the chunk, the location of which is determined by the device address (each 64B block could even be in a different location, depending on how addresses are interleaved between memory controllers and memory chips). Optionally, a software component (e.g., agent or operating system component) sends multiple 64B data fetch requests to the memory subsystem to fetch the chunk, the location of which is determined by the device address.

The example CPT entries with indexes i, j, k, l, m, and n respectively correspond to the compression schemes shown in diagrams 300a, 300b, 300c, 300d, 300e, and 300f when the examples in these diagrams are stored back-to-back. The delta between device addresses for pairs of sequential entries is equal to the aggregate compressed size of the first page in the pair. Thus, while the PHYS_C addresses for consecutive pages are 4K (4096 B) apart, the device addresses for consecutive pages will be less than 4K and will vary.

### Transparent Decompression Overview and Pattern Detection

When there is an access to data stored in the compressed partition, the request is forwarded to the Transparent Decompression Engine (TDE). The TDE first locates the compressed data in memory using the CPT. Next, the TDE fetches the compressed data from memory, and decompresses it using hardware decompression cores. The requested cache line is sent back to the core that issued the request, and the rest of the decompressed chunk is stored on-chip for future accesses (either in a separate cache in the TDE or in the existing on-chip caches). This avoids decompressing the same chunk again when another cache line in the chunk is needed in the near future, such as when there is spatial locality in the access pattern.

Ideally, only the data that is needed should be decompressed. If there is no spatial locality, e.g., only a single cache line is accessed in a page within a certain time frame, decompressing the full page has a large overhead and is mostly useless. Therefore, this data should be compressed in the smallest chunk size, resulting in fast decompression. If there is locality, e.g., all cache lines in a page are accessed sequentially, we can use larger compression chunks (up to a page), because all data is needed and larger chunks enable more compression (a larger compression ratio), and thus more capacity savings. Selecting the right chunk size for all data structures leads to the highest capacity savings while minimizing the performance overhead.

To that end, we extend the TDE with a Pattern Access Profiler (PAP), which records the locality of accesses to cache lines in a page. This profiler provides hints to the OS, which then decides how to compress a certain data structure. We assume that the access pattern to all pages of a certain data structure or (virtual) memory region is the same within a certain program phase. The PAP is added to the CPT cache: a small cache on the TDE that keeps the latest accessed CPT entries to avoid fetching the CPT from memory.

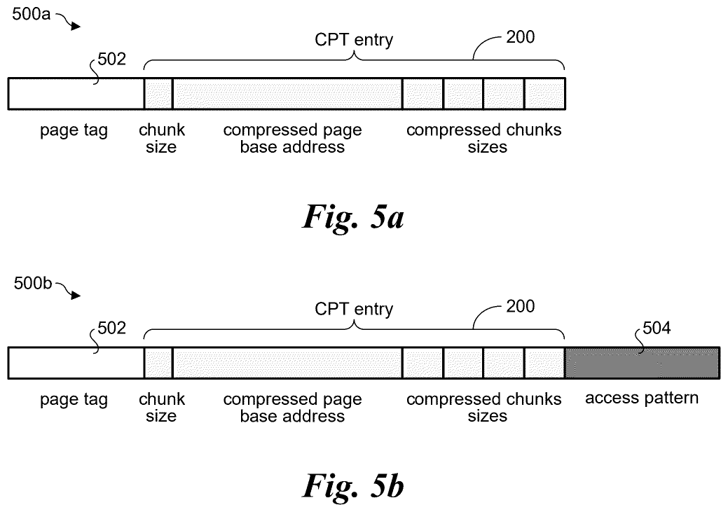

FIG. 5a shows the organization of a CPT cache line 500a, according to one embodiment. The first field is a page tag field 502 that contains the page tag, which identifies the page for which this CPT cache line stores the CPT data. If there is a match between the page of the requested cache line and this tag, the cached CPT entry can be used, and the CPT entry does not need to be fetched from memory. The next information, in light gray, contains the CPT entry 200 data, which is the same as shown in CPT entry 200 in FIG. 2 and described above: a chunk size, a compressed page base address field, and one or multiple fields denoting sizes of chunks in the compressed page. This information enables fetching the compressed chunk containing the requested cache line from memory.

FIG. 5b shows the organization of a profiled/sampled CPT cache line 500b. In addition to the fields in CPT cache line 500a, a profiled/sampled CPT cache line also includes an access pattern field 504 appended at the end of the data structure. The access pattern field 504 is added to a few sampled CPT cache entries. In one embodiment, approximately 1% of the entries are sampled, e.g., one in 64 or 128. Using a power of 2 enables selecting sampled pages based on the least-significant bits of the page tag. Access pattern field 504 has one bit for every 64 B cache line in the 4 KB page, so 64 bits in total. On an access to compressed data, the CPT cache is checked to see if an associated CPT cache entry is present in the CPT cache. If this results in a hit and it belongs to the sampled entries, the bit of the requested cache line is set in the access pattern field. If it results in in a miss, the CPT entry is fetched from memory, and added to the cache, with only the requested cache line's bit set to 1 in the access pattern for the sampled entries.

When a sampled CPT cache line is evicted (to make room for another CPT cache line), the access pattern is analyzed. If only one bit, or a few bits scattered over the 64-bit field, are set between the time the CPT cache line was allocated and the time it is evicted, the pattern has no locality, and should use the smallest possible chunk size. If all or most bits are set, the pattern has high locality, and should use the largest chunk size. If a few consecutive bits are set, an intermediate chunk size might be beneficial: e.g., if 4 consecutive bits are set (and the rest is not set), the data structure is accessed in 256 B (4×64 B) chunks, so compressing the data in 256 B chunks is optimal.

The optimal chunk size and page tag of evicted sampled CPT cache lines is stored in a circular buffer, readable by the operating system. Periodically, the OS checks this buffer to monitor the optimal compression chunk size of recently accessed pages, as described in the next section. Sampling only a few (e.g., one in 64 or 128) CPT cache entries reduces the required capacity of (and write bandwidth to) this circular buffer. In one embodiment only large data structures (e.g., more than 100 MB) are considered for compression, because small data structures result in low potential capacity savings. As such, each compressed data structure should have multiple sampled pages, such that we can meaningfully record its access pattern.

### Optimal Compression Chunk Size Selection by the OS

As mentioned above, the operating system is responsible for compressing data and selecting the compression chunk size. It makes use of the PAP to make this decision. This section describes the OS additions and algorithms to perform optimal chunk size compression per memory region.

First, during a setup phase the OS relates the sampled page access profiles in the circular buffer to a virtual memory region. The circular buffer stores physical addresses, while memory regions are logically defined using virtual addresses (consecutive chunks of memory allocated by the application). Consecutive virtual memory pages might not be stored consecutively in physical memory, which is why we need to translate the physical page address back to a virtual address.

When an application allocates a large (e.g., >100 MB) data structure, the memory allocation library usually calls the mmap OS method, which creates a new virtual memory area (vma). However, for efficiency reasons, vmas might be merged into a single vma, breaking the unique relationship between a vma and a data structure. Furthermore, the access pattern to a data structure might not be uniform for all pages, with some regions having a denser access pattern than others. Therefore, in one embodiment the virtual memory space of a compressible data structure is divided into smaller-sized compressed memory regions (cmr).

Each cmr has a fixed size, e.g., 2 MB, and corresponds to a virtual address range. The number of cmrs in a vma is a function of the size of the cmrs and the size of the vma. As an example, for a cmr size of 2 MB a 1 GB vma has 512 cmrs, each with a 2 MB virtual address offset from each other. We assume a homogeneous access pattern within each cmr. Each vma keeps an array cmr entries. Additionally, we add a (system-wide) mapping in the OS between the physical address of the sampled pages and a cmr entry, identified by its corresponding vma and cmr id within the vma. Because only a small number of pages are sampled, and only a part of them belong to a compressible data structure and thus a cmr, in one embodiment this mapping is implemented using a hash map (in the OS software). The hash map should return NULL for physical pages that were not mapped, to avoid random cmr mappings.

The hash map returns the vma and the cmr id, which is sufficient to reconstruct the virtual memory range for that cmr. For example, given a physical address of a sampled page, the mapping returns that this page belongs to vma 1 of app 2 and it is cmr 156 of that vma. The virtual memory range corresponding to that cmr starts at the base virtual address of vma 1 of app 2 plus 156 times the cmr size (e.g., 2 MB). If that cmr needs to be recompressed, the corresponding physical pages can be found by translating the virtual pages of that cmr using the conventional page table.

When multiple applications (processes) share data structures, they each have their separate vma that corresponds to the same set of physical pages. In this case, the physical to cmr mapping is recorded only for the first page fault, i.e., the first application that accesses this page. This ensures a unique mapping between the sampled physical pages and a cmr. Accesses by the other applications to that physical page will be profiled in the cmr of the application that first accessed that page.

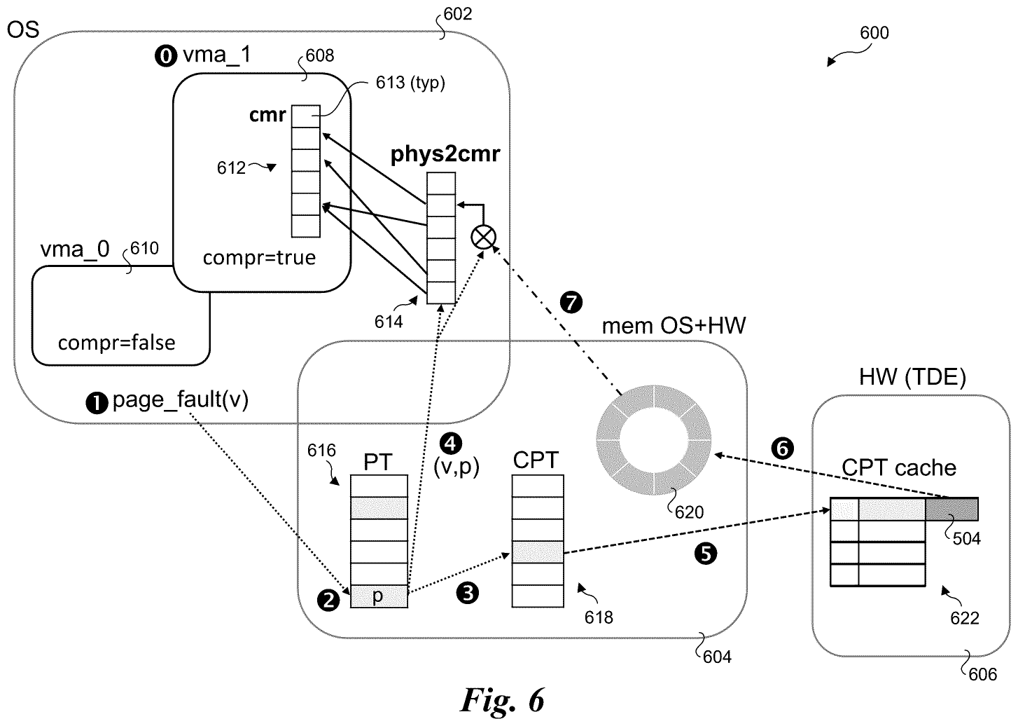

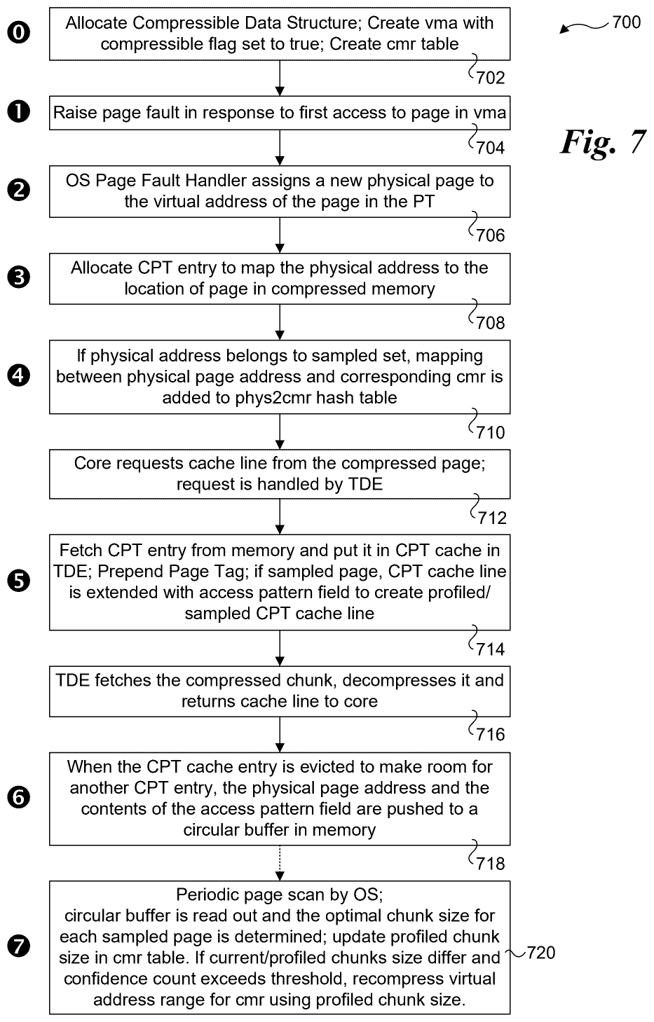

FIG. 6 shows a diagram 600 illustrating how cmrs and the physical address to cmr mapping works. Diagram consists of three regions: OS-internal structures 602, data structures in memory that are accessible by both OS (read+write) and HW (read only) (mem OS+HW 604), and hardware structures (the TDE, with only the CPT cache show, depicted as HW (TDE) 606). OS-internal structures 602 includes vma's 608 and 610, also labeled and referred to as vma_1 and vma_0. Vma_1 includes a cmr table 612 with cmrs 613 and a physical-to-cmr (phys2cmr) hash table 614. mem OS+HW 604 includes a portion of a page table (PT 616) with associated page table entries, a CPT 618, and a circular buffer 620. HW (TDE) 606 shows a CPT cache 622. In addition, diagram 600 shows operations depicted as encircled numbers that are also included in flowchart 700 in FIG. 7.

With reference to flowchart 700, in a block 702 (operation ‘0’) a compressible (e.g., large) data structure is allocated. When a compressible data structure is allocated, a vma (vma_1) is created with the compressible flag set to true (or the allocated memory range is merged with another compressible range in the same vma) and a cmr table (612) is created, which contains the chunk size per cmr 613. Only compressible vmas contain a cmr table, non-compressible vmas (with small data structures, code, etc.,) have no cmr table, as depicted for vma_0. The size of the cmr table equals the size of the vma virtual address range divided by the cmr fixed size. For example, 1 GB allocated memory with 2 MB cmr has 512 cmr table entries.

On the first access to a page in vma_1, a page fault is raised (operation ‘1’), as shown in a block 704. In the OS page fault handler, the OS assigns a new physical page ‘p’ to the virtual address of the page in PT 616, as depicted in a block 706 (operation ‘2’). Additionally, because the page belongs to a compressible region, a CPT entry is allocated to map the physical address to the location of the compressed page in memory, as shown in a block 708 (operation ‘3’). As depicted in a block 710 (operation ‘4’), if the physical page address belongs to the sampled set (indicated in light gray in diagram 600), the mapping between the physical page address and the corresponding cmr is added to phys2cmr hash table 614. The corresponding cmr is found by mapping the virtual address to the vma, and then calculating the cmr offset from the virtual page address. Note that multiple sampled pages can map to the same cmr. For example, with 2 MB cmr (512 4 KB pages) and a sampling rate of 1/128, 4 (512/128) sampled pages will map to the same cmr.

As shown in a block 712, when a core requests a cache line from the compressed page, the request is handled by the TDE. In a block 714 the TDE first fetches the CPT entry from memory (operation ‘5’) and puts it in CPT cache 622. The TDE generates a page tag for the page, which can be derived from the index of the CPT entry, and prepends the page tag to create a CPT cache line. If it is a sampled page, the CPT cache line is extended with the access pattern field 504 and becomes a profiled/sampled CPT cache line. In a block 716, the TDE fetches the compressed chunk, decompresses it and returns the cache line to the core.

On every access to the same page, the access pattern is recorded in the CPT cache. When the CPT cache entry is evicted to make room for another CPT entry, the physical page address and the contents of the access pattern field are pushed to a circular buffer in memory (operation ‘6’), as depicted in a block 718.

As shown in a block 720, during the periodic page scan phase in the OS the circular buffer is read out (operation ‘7’) and the optimal chunk size for each sampled page that is read out is determined. The physical page address is sent through the phys2cmr hash table to find the cmr table entry that corresponds to that page, and the chunk size is updated. If the chunk size has changed, the virtual address range corresponding to the cmr is recompressed using the new (profiled) chunk size.

To avoid too many recompressions, which have a significant overhead, in one embodiment a confidence counter can be kept at each cmr entry to only recompress if we have profiled the same new chunk size a number of times. Under this approach a cmr entry may include a current chunk size, a profiled chunk size, and a count of the profiled chunk size. Optionally, a cmr entry may include the access pattern as recorded by the TDE (64-bit pattern), which can then be interpreted by the OS to determine the profiled chunk size. When the count exceeds a threshold and the current chunk size and profiled chunk size are different, the cmr is recompressed using the profiled chunk size with the current chunk size being updated to the profiled chunk size and the count reset to 0.

Because the TDE might dump the cache lines of the decompressed chunk into the LLC (depending on its implementation), accesses to cache lines within a decompressed chunk might not be recorded, since they fetch their data directly from the LLC and don't access the TDE. Only uncompressed pages that are stored in the compressed memory partition or pages compressed using a small chunk size (e.g., one cache line) access the TDE for each cache line, enabling the recording of the access pattern within a page. Therefore, under one embodiment sampled pages are kept uncompressed or compressed using a small chunk size, even if they have a high-locality pattern, such that we can profile all pattern access changes. The remaining non-sampled pages in a cmr are compressed at the profiled chunk size. Because we only sample approximately 1% of pages, this does not significantly impact the overall compression ratio.

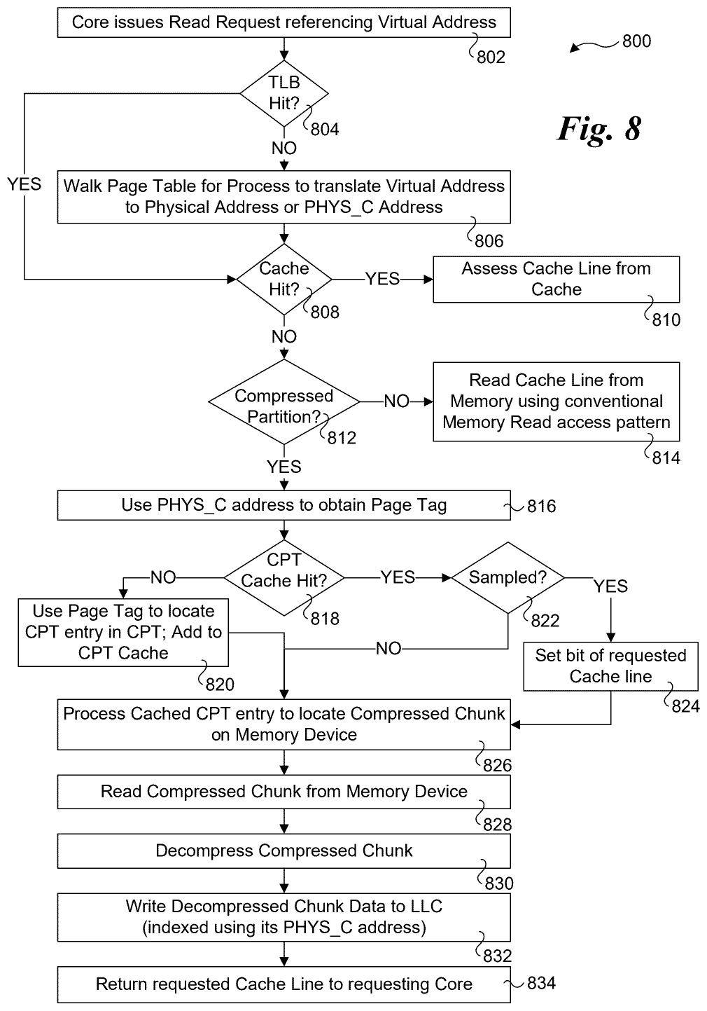

FIG. 8 shows a flowchart 800 illustrating operations and logic perform for a Read request to access data. For this example, it is presumed that any access to a compressed page is a subsequent access that does not result in a page fault. The process begins in a block 802 with a core issuing a Read request referencing a virtual address of a requested cache line. Rather than use physical memory with physical addressing, operating systems utilize virtual memory with virtual addressing. However, since the memory devices themselves utilize physical addressing, there needs to be a translation from the virtual address of the cache line to the physical address of the cache line. Coherent cache architectures employ Translation Look-aside Buffers (TLBs) that contain page-table entries that map virtual addresses to physical addresses. A TLB may be implemented as a content-addressable memory (CAM). The CAM search key is the virtual address, and the search result is the physical address. If the requested virtual address is present in the TLB, the CAM search yields a match quickly and the retrieved physical address can be used to access memory. This is called a TLB hit.

As shown in a decision block 804 a determination is made to whether there is a TLB hit. For some cache designs, there may be multiple TLBs that are searched. If there is a hit for any of the TLBs, the answer to decision block 804 is YES and the physical address of the cache line is determined using a virtual-to-physical address translation. For example, the physical address may be an address offset from the start of a physical page address for a page table entry in a TLB. The physical address is then used to determine whether the cache line is present in one of the cache levels (L1, L2, or L3/LLC). As depicted by a decision block 808, if the cache line is present in a cache the result is a cache hit, and the cache line is accessed from the cache in a block 810.

For illustrative purposes, the TLB hit and cache hit approach shown here is a simplified representation of how a cache line that is cached on-chip (in a local L1/L2 cache or shared LLC) is accessed. Well-known operations such as snoops and the like are not shown for simplicity, but will be understood by those skilled in the art to be used in accordance with the coherent memory architecture of a given system design.

If there is not a TLB hit, the logic proceeds to a block 806 where the page table for the process (requesting the cache line) is identified and walked to translate the virtual address to a physical address or PHYS_C address. This uses the conventional page table walker implemented by existing operating systems, where the processID or virtual address may be used to identify the applicable page table (for the process) to walk. Block 806 returns a physical address corresponding to the physical address of the cache line in plain DRAM or a PHYS_C address used for accessing a cache line in the compressed partition.

The physical address or PHYS_C address is then used to determine whether the cache line is present in an L1, L2, or L3 cache. If there is a cache hit, the cache line is access from the cache in block 810, as before. If there is a cache miss, the answer to decision block 808 is NO and the logic proceeds to a decision block 812 to determine whether the cache line is in the compressed partition. In one embodiment the memory controller utilizes the most significant (MS) bits of the physical address or PHYS_C address to determine where the cache line is located in the compressed partition. If the answer is NO, the cache line is in plain (uncompressed) memory, and the cache line is read from the applicable memory device using a conventional memory read access pattern, as depicted in a block 814.

If the cache line is in the compressed partition, the answer to decision block 812 is YES and the logic proceeds to a block 816 in which a page tag is obtained using the PHYS_C address. In a decision block 818, the page tag is used to determine whether there is a CPT cache hit. If there are no CPT cache entries with the page tag, the result is a miss (NO) and the logic proceeds to use the page tag to locate a CPT entry in the CPT with the page tag (here the page tag is being used as the index for the CPT 400 shown in FIG. 4). The CPT entry with the page tag is then added to the CPT cache, which will evict one of the CPT entries in the CPT cache. If there is a CPT cache hit a determination is made to whether the page tag corresponds to a sampled page in a decision block 822. If the answer is YES, the bit for the requested cache line is set, as shown in a block 824.

As illustrated, the logic proceeds from one of block 820, decision block 822 (if NO) or block 824 to a block 826 in which information in the CPT entry is used to locate the compressed chunk on a memory device in system memory. As described above, the device address in the CPT entry is used to locate the start of the compressed page in memory, including the memory device containing that compressed page. For a memory controller supporting multiple memory channels, the memory controller will also identify what memory channel is used to access the memory device. The encoded chunk size 202 and fields 206 denoting the sizes of each compressed chunk is used to identify the offset of the compressed chunk from the start of the compressed page and the size of the compressed chunk.

The compressed chunk is then read from the memory device in a block 828. TDE sends multiple 64B data fetch requests to the memory subsystem to fetch the compressed chunk. The data in the compressed chunk are decompressed in a block 830 to obtain uncompressed data comprising multiple 64B cache lines. The decompression is performed in hardware using a decompression core or other type of decompression accelerator.

In a block 832 the decompressed chunk data are written to the LLC as new cache lines and indexed using the PHYS_C address. The process is completed in a block 834 by returning the requested cache line to the requesting core using a conventional LLC access pattern. For example, in one embodiment cache agents for the LLC and L1/L2 caches copy the cache line from the LLC to the L2 cache and the L1 Instruction cache or L1 Data cache. Under other cache architectures, the cache line may be copied to the L1 Instruction cache or L1 Data cache without copying the cache line to the L2 cache.

In the foregoing description, reference is made to a compressed chunk. As described and illustrated in the examples above, a compressed page may contain both compressed chunks and uncompressed chunks. Data contained in an uncompressed chunk in a compressed page is accessed in a similar manner to data in a compressed chunk, except there is no decompression of that data. Thus, in block 828 the uncompressed chunk of data would be read, block 830 would be skipped, and in block 832 the chunk of uncompressed data will be written to the LLC.

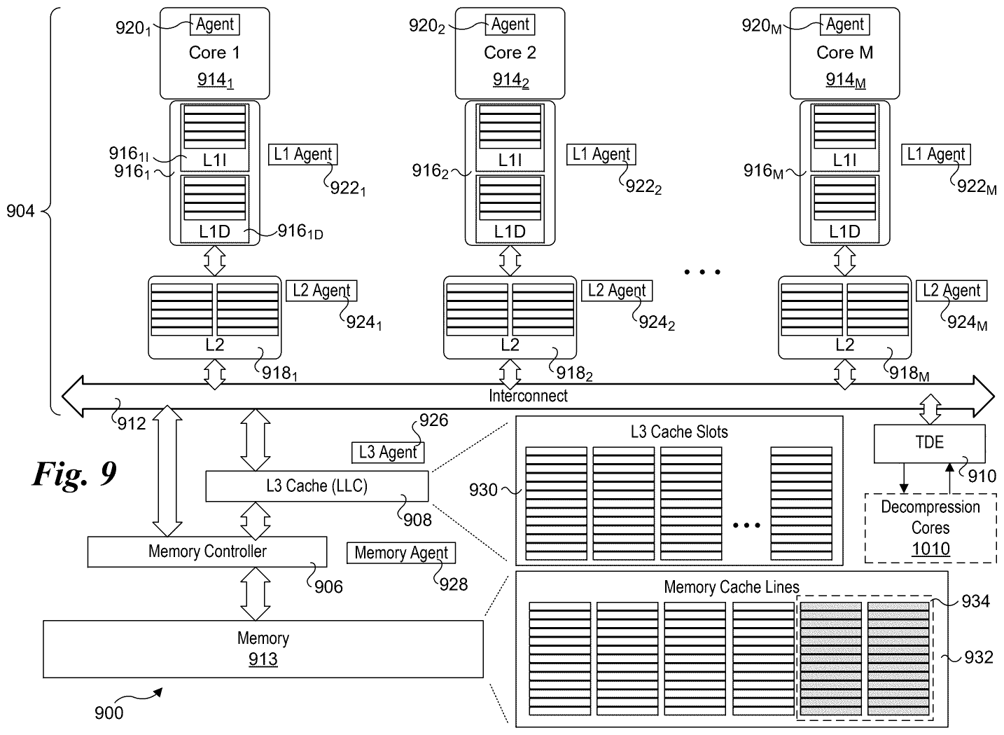

FIG. 9 shows selected hardware components of an exemplary computing platform 900. The hardware components include a CPU having a core 904 coupled to a memory controller 906, a last level cache (LLC) 908 and a TDE 910 via an interconnect 912. In some embodiments, all or a portion of the foregoing components may be integrated on a System on a Chip (SoC). Memory controller 906 is configured to facilitate access to system memory 913, which will usually be separate from the SoC. For example, system memory may comprise one or more memory devices supporting one or more memory standards, such as DRAM DIMMs (Dual Inline Memory Modules) having standardized form factors.

CPU core 904 includes M processor cores 914, each including a respective local level 1 (L1) cache 916 and a local level 2 (L2) cache 918 (the cores and the L1 and L2 caches 916 and 918 are depicted with subscripts indicating the core they are associated with, e.g., 916₁ and 918₁ for core 914₁). Optionally, the L2 cache may be referred to as a “middle-level cache” (MLC). As illustrated in this cache architecture, an L1 cache 916 is split into an L1 instruction cache 916₁ and an L1 data cache 916_{D} (e.g., 91611 and 916_{1D} for core 914₁).

Computing platform 900 employs multiple agents that facilitate transfer of data between different levels of cache and memory. These include core agents 920, L1 agents 922, L2 agents 924, an L3 agent 926, and a memory agent 928. The L1, L2, and L3 agents are also used to effect one or more coherency protocols and to perform relating operations, such as snooping, marking cache line status, cache eviction, and memory writebacks. L3 agent 926 manages access to and use of L3 cache slots 930 (which are used to store respective cache lines). Data is also stored in memory 913 using memory cache lines 932. Memory cache lines that are part of the compressed partition are depicted as memory cache lines 934 and are used to store compressed data.

For simplicity, interconnect 912 is shown as a single double-ended arrow representing a single interconnect structure; however, in practice, interconnect 912 is illustrative of one or more interconnect structures within a processor or SoC or System on Package (SoP), and may comprise a hierarchy of interconnect segments or domains employing separate protocols and including applicable bridges for interfacing between the interconnect segments/domains. For example, the portion of an interconnect hierarchy to which memory and processor cores are connected may comprise a coherent memory domain employing a first protocol, while interconnects at a lower level in the hierarchy will generally be used for IO access and employ non-coherent domains. The interconnect structure on the processor or SoC may include any existing interconnect structure, such as buses and single or multi-lane serial point-to-point, ring, torus, or mesh interconnect structures (including arrays of rings or torus).

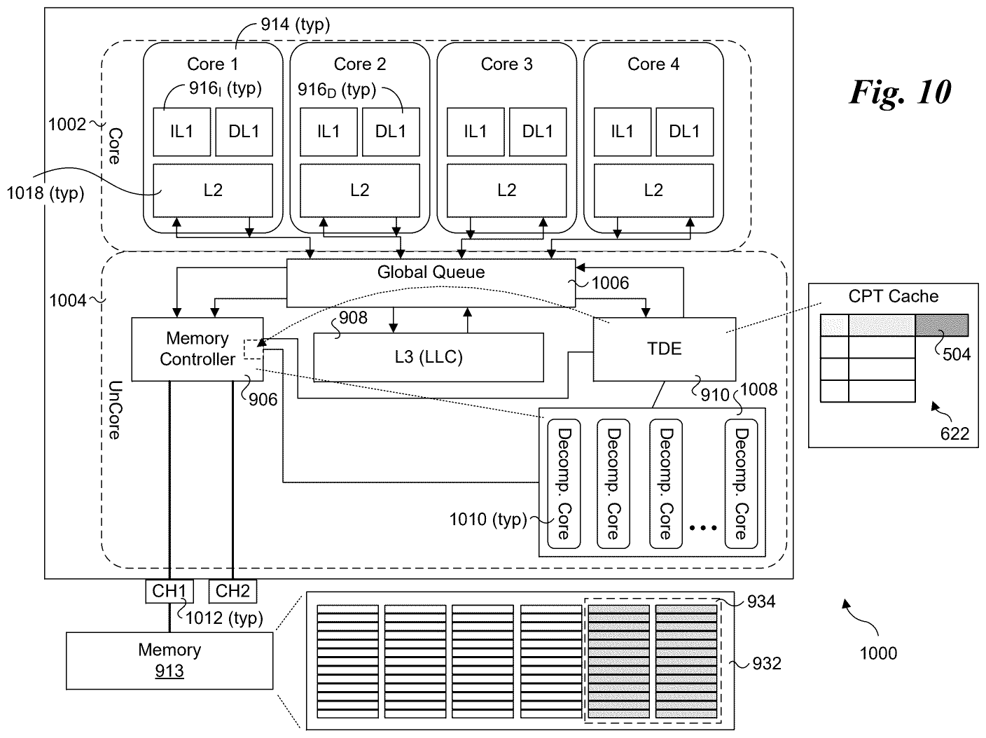

FIG. 10 shows an SoC 1000 implementing a memory coherency architecture employed by the embodiment of FIG. 9. Under this and similar architectures, such as employed by some Intel® and AMD® processors, the L1 and L2 caches are part of a coherent memory domain under which memory coherency is managed by coherency mechanisms in the processor core 1002. As in FIG. 9, each core 914 includes an L1 instruction (IL1) cache 916I, and L1 data cache (DL1) 916_{D}, and an L2 cache 918. In some embodiments L2 caches 918 are non-inclusive, meaning they do not include copies of any cachelines in the L1 instruction and data caches for their respective cores. As an option, L2 may be inclusive of L1, or may be partially inclusive of L1. In addition, L3 may be inclusive of L1 and/or L2 or non-inclusive of L1/L2. Under another option, L1 and L2 may be replaced by a cache occupying a single level in cache hierarchy.

Meanwhile, the LLC is considered part of the “uncore” 1004, wherein memory coherency is extended through coherency agents (e.g., L3 agent 926 and memory agent 928). As shown, uncore 1004 (which represents the portion(s) of the SoC circuitry that is external to core 1002) includes memory controller 906 coupled to external memory 913 and a global queue 1006. Global queue 1006 also is coupled to an L3 cache 908, and TDE 910. Memory controller 906 includes memory device interface circuitry comprising one or more memory channels (CH) 1012. In some embodiments, a memory device, such as a DIMM may include input/output (I/O) circuitry for two memory channels, while other memory devices may provide I/O circuitry for a single memory channel.

As is well known, as you get further away from a core, the size of the cache levels increase, but so does the latency incurred in accessing cachelines in the caches. The L1 caches are the smallest (e.g., 32-80 KiloBytes (KB)), with L2 caches being somewhat larger (e.g., 256 KB to 2 MegaBytes (MB)), and LLCs being larger than the typical L2 cache by an order of magnitude or so (e.g., 30-100+MB). Of course, the size of these caches is dwarfed by the size of system memory (on the order of GigaBytes of even TeraBytes for some servers). Generally, the size of a cacheline at a given level in a memory hierarchy is consistent across the memory hierarchy, and for simplicity and historical references, lines of memory in system memory are also referred to as cache lines even though they are not actually in a cache. It is further noted that the size of global queue 1006 is generally quite small, as it is designed to only momentarily buffer cachelines that are being transferred between the various caches, memory controller 906, and TDE 910.

Uncore 1004 further includes a decompression block 1008 comprising a plurality of decompression cores 1010 coupled to TDE 910. Decompression cores 1010 may also be referred to as decompression accelerators. Decompression cores 1010 comprise circuitry for performing decompression operations on compressed data accessed from memory 913. TDE 910 is used to control access to decompression cores 1010 and implement CPT cache 622, as described above. As further shown in FIG. 10, as an alternative to having a separate circuitry block for TDE 910, circuitry for implementing the functionality for a decompression controller may be included as part of memory controller 906. As yet another option, both a TDE and decompression cores 1010 may be implemented as part of memory controller 906.

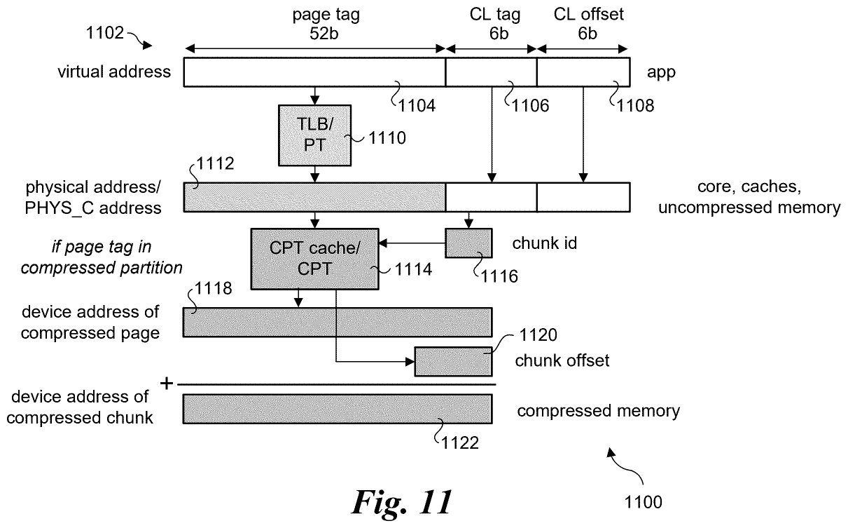

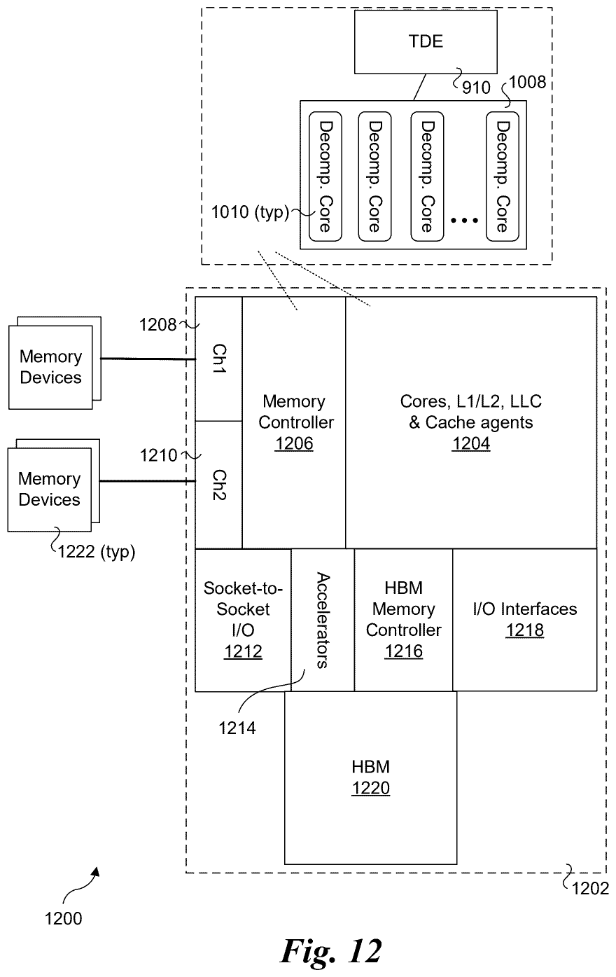

FIG. 11 shows a diagram 1100 illustrating how addresses, tags and indices are handled. The application uses 64-bit virtual addresses 1102, which are split into a cache line (CL) offset 1108 (6 bits for conventional 64 B CLs), a CL tag 1106, to locate the cache line within a page (assuming 4 KB pages, so 64 CLs per page and 6 bits to locate them) and a page tag 1104 consisting of the remaining 52 bits.

The page tag is translated to a physical page tag through the TLB (=PT cache on chip) or the PT if the TLB misses (both collectively depicted as TLB/PT 1110). If the PT does not contain an entry for the virtual page tag, a page fault is raised, and the OS allocates a physical page and adds the translation to the PT. The physical address 1112 (which can be a plain uncompressed physical address or a PHYS_C address) is used by the cores and on-chip caches.

If this page belongs to the compressed partition (by checking if the page tag is larger than the compressed memory partition start address), the OS also allocates a CPT entry for that page on a page fault. If that page is accessed later on and misses in all on-chip caches, the page tag (i.e., the upper 52 bits of the PHYS_C address, potentially reduced by subtracting the compressed memory start address to reduce its size) is used to first check if the CPT entry is in the CPT cache (page tag field in the CPT cache), and if not, the page tag is used to index the CPT in memory. This is collectively represented by CPT cache/CPT 1114. The CPT entry provides the memory address (device address) 1118 of the compressed page. The upper bits of the cache line tag are used to determine the chunk id 1116 (e.g., for 1 KB chunks, we use the 2 upper bits to determine which of the 4 chunks is needed), which is then used to find the offset of the compressed chunk 1120 in the compressed page (by adding the size fields in the CPT entry).

After the compressed chunk is fetched and decompressed, the remainder of the CL tag (the part not used in the chunk id) is used to locate the requested CL in the decompressed chunk, as depicted by device address of compressed chunk 1122.

FIG. 12 shows a system 1200 including a System-on-Package (SoP) 1202. SoP 1202 includes a block or tile 1204 including multiple cores, L1/L2 caches, an LLC, and cache agents, a memory controller 1206 including memory channels 1208 and 1210, a socket-to-socket I/O interface 1212, accelerators 1214, a high bandwidth (HBM) memory controller 1216, an I/O interfaces block 1218 and HBM 1220. Each of memory channels 1208 and 1210 is coupled to one or more memory devices 1222. As depicted at the top of FIG. 12, TDE 910 and decompression cores or accelerators 1010 in decompression block 1008 may be integrated on memory controller 1206 or on block or tile 1204.

In one embodiment accelerators 1214 include a plurality of decompression accelerators and compression accelerators, which are separate from decompression cores or accelerators 1010. In some embodiments accelerators 1214 represent accelerators associated with one of more of Intel® IAA, QAT (QuickAssist Technology), and/or DLB (Dynamic Load Balancer).

Memory devices 1222 represent volatile memory. Volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). A memory subsystem as described herein may be compatible with a number of memory technologies, such as DDR3 (Double Data Rate version 3) JESD79-3F, originally published by JEDEC (Joint Electronic Device Engineering Council) in June 2007. DDR4 (DDR version 4), JESD209-4D, originally published in September 2012, DDR5 (DDR version 5), JESD79-5B, originally published in June 2021, DDR6 (DDR version 6), currently in discussion by JEDEC, LPDDR3 (Low Power DDR version 3, JESD209-3C, originally published in August 2015, LPDDR4 (LPDDR version 4, JESD209-4D, originally published in June 2021), LPDDR5 (LPDDR version 5, JESD209-5B, originally published in June 2021), WIO2 (Wide Input/Output version 2), JESD229-2, originally published in August 2014, HBM (High Bandwidth Memory, JESD235B, originally published in December 2018, HBM2 (HBM version 2, JESD235D, originally published in March 2021, HBM3 (HBM version 3, JESD238A originally published in January 2023) or HBM4 (HBM version 4), currently in discussion by JEDEC, or others or combinations of memory technologies, and technologies based on derivatives or extensions of such specifications. The JEDEC standards are available at www.jedec.org.

Memory devices 1222 are representative of either memory chips supporting on or more of the foregoing standards and/or packaged memory devices including such memory chips, such as DIMMs, SODIMMs (Small Outline DIMMs) and CAMM (Compression Attached Memory Modules) devices. Generally, DIMMs, SODIMMs and CAMM devices will be installed in or attached to mating connectors on a system board or the like in which an SoC or SoP is installed.

HBM 1220 is representative of existing and future HBM memory devices supporting one or more of HTM, HBM2, HBM3, and/or HBM4. HBM memory may be tightly coupled with other circuitry in an SoP package, such as using a stacked 3D architecture or a tile or chiplet architecture. For example, all the circuit blocks/tiles shown for SoP 1202 except for HBM 1220 may comprise an SoC or the like, with HBM 1220 coupled to the SoC.

Socket-to-Socket I/O interfaces 1212, which are optional, are used to support socket-to-socket communication in a multi-socket platform. Non-limiting examples of multiple socket platforms may include 2 sockets, 4 sockets, or more sockets. Under the terminology “socket” used here, an instance of SoP 1202 would be installed in a respective socket on a system board or the like or could be directly mounted to the system board. In the art, the term “socket” in a multi-socket platform refers to a processor, SoC, or SoP whether the processor, SoC, or SoP is installed in a socket or mounted to a system board without a socket. When there are 4 or more sockets, the socket-to-socket communication paths may be arranged in a daisy-chain, a daisy-chain with cross connections and/or variations thereof.

The I/O interfaces in I/O interface block 1218 are generally illustrative of I/O interfaces configured in accordance with one or more I/O standards. This includes any type of I/O interface, such as but not limited to Peripheral Component Interconnect express (PCIe), Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Intel® QuickPath Interconnect (QPI), Intel® Ultra Path Interconnect (UPI), Intel® On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

The following examples pertain to additional examples of the teachings and principles disclosed herein.
Example 1. An example method can be implemented on a computing platform including a processor having multiple cores and coupled to system memory comprising one or more memory devices and hosting an operating system. The method includes storing respective data in the system memory as compressed data and uncompressed data, profiling access patterns to the compressed data; and determining, in view of the profiled access patterns, compression schemes to use to selectively recompress portions of the compressed data.
Example 2. The method of claim 1, wherein profiling access patterns to the compressed data comprises sampling access patterns to the compressed data and generating access pattern data for respective regions.
Example 3. The method of claim 1 or 2, further comprising: in response to memory read request for a cache line issued by a core, determining the cache line is stored in the compressed data; fetching a compressed chunk of data containing the cache line; decompressing, using hardware decompression, the compressed chunk of data to obtain decompressed data including the cache line; and returning the cache line to the core that issued the request.
Example 4. The method of claim 3, further comprising: maintaining a compressed page table (CPT) comprising respective CPT entries for compressed pages; identifying a CPT entry corresponding to a compressed page containing the compressed chunk of data containing the cache line; and copying the CPT entry to a CPT cache.
Example 5. The method of claim 4, further comprising: maintaining access pattern data for the CPT entry in the CPT cache; and when the compressed page corresponding to the CPT entry is accessed while the CPT entry is in the CPT cache, updating the access pattern data for the CPT entry.
Example 6. The method of claim 5, further comprising: copying the access pattern data and indicia from which the compressed page can be identified to a memory buffer; and accessing, via the operating system, the access pattern data from the memory buffer.
Example 7. The method of any of the preceding claims, further comprising: allocating a compressible data structure for an application; creating a virtual memory area (vma) to be used for the compressible data structure; dividing the vma into a plurality of compressed memory regions (cmrs); and creating a cmr table containing respective cmr entries for each cmr.
Example 8. The method of claim 7, further comprising: maintaining, in a cmr entry, indicia for a current compression scheme used for a cmr; determining, based on profile access pattern data for one or more pages in the cmr, a profiled compression scheme to be used for pages in the cmr; when the profiled compression scheme is different than the current compression scheme, recompressing pages in the cmr using the profiled compression scheme and updating the indicia corresponding to the current compression scheme in the cmr entry to correspond to the profiled compression scheme.
Example 9. The method of claim 7 or 8, further comprising maintaining mapping information that maps addresses for compressed pages to cmrs.
Example 10. The method of any of the preceding claims, wherein the compression schemes define chunk sizes used to store compressed data.
Example 11. A non-transitory machine-readable medium having instructions stored thereon configured to be executed on one or more cores of a multiple processor of a computing platform having multiple cores and coupled to system memory comprising one or more memory devices, wherein execution of the instructions enabled the computing platform to: store respective data in the system memory as compressed data and uncompressed data; access profiled access patterns to the compressed data; and determine, in view of the profiled access patterns, compression schemes to use to selectively recompress portions of the compressed data.
Example 12. The non-transitory machine-readable medium of claim 11,
wherein execution of the instructions further enables the computing platform to: allocate a compressible data structure for an application; create a virtual memory area (vma) to be used for the compressible data structure; divide the vma into a plurality of compressed memory regions (cmrs); and create a cmr table containing respective cmr entries for each cmr.
Example 13. The non-transitory machine-readable medium of claim 12,
wherein execution of the instructions further enables the computing platform to: maintain, in a cmr entry, indicia for a current compression scheme used for a cmr; determine, based on profile access pattern data for one or more pages in the cmr, a profiled compression scheme to be used for pages in the cmr; when the profiled compression scheme is different than the current compression scheme, recompressing pages in the cmr using the profiled compression scheme and updating the indicia corresponding to the current compression scheme in the cmr entry to correspond to the profiled compression scheme.
Example 14. The non-transitory machine-readable medium of claim 12,
wherein execution of the instructions further enables the computing platform to: maintain, in a cmr entry, indicia for a current compression scheme used for a cmr; determine, based on profile access pattern data for one or more pages in the cmr, a profiled compression scheme to be used for pages in the cmr; maintaining confidence indicia for the profiled compression scheme; when the profiled compression scheme is different than the current compression scheme and the confidence indicia meets a threshold condition, recompress pages in the cmr using the profiled compression scheme and update the indicia corresponding to the current compression scheme in the cmr entry to correspond to the profiled compression scheme.
Example 15. The non-transitory machine-readable medium of any of claims 12-14, wherein execution of the instructions further enables the computing platform to maintain mapping information that maps addresses for compressed pages to cmrs.
Example 16. The non-transitory machine-readable medium of any of claims 12-15, wherein execution of the instructions further enables the computing platform to partition a physical address space for the system memory to include an uncompressed partition in which data are stored without compression and a compressed partition in which compressed data are stored.
Example 17. The non-transitory machine-readable medium of any of claims 12-16, wherein the computing platform generates profiled access pattern data that is copied to a buffer in memory, and wherein execution of the instructions enable the computing platform to periodically read profiled access pattern data from the buffer.
Example 18. The non-transitory machine-readable medium of any of claims 12-17, wherein the profiled access pattern data is profiled to accesses to an associated sampled page and includes associated page indicia, and wherein execution of the instructions enable the computing platform to: access profiled access pattern data for a sampled page; determine a cmr corresponding to the sampled page; and at least one of, add the profiled access pattern data to the cmr; and employ the profiled access pattern data to determine a profiled compression scheme for the cmr.
Example 19. A system comprising: system memory comprising a plurality of memory devices; software comprising executable instructions associated with an operating system and processes for applications to be run on the operating system; a multi-core processor comprising, multiple processor cores having associated level 1 (L1) and level 2 (L2) caches; and a memory controller having an interface comprising one or more memory channels coupled to one or more of the plurality of memory devices. The system is configured to, store respective data in the system memory as compressed data and uncompressed data; profile access patterns to the compressed data; and determine, in view of the profiled access patterns, compression schemes to use to selectively recompress portions of the compressed data.
Example 20. The system of claim 19, further configured to: maintain a compressed page table (CPT) comprising respective CPT entries for compressed pages; in response to memory read request for a cache line issued by a core, determine the cache line is in the compressed data; identify a CPT entry corresponding to a compressed page containing a compressed chunk of data including the cache line; and copy the CPT entry to a CPT cache.
Example 21. The system of claim 20, further configured to: fetch the compressed chunk of data including the cache line; decompress, using hardware decompression, the compressed chunk of data to obtain decompressed data including the cache line; and return the requested cache line to the core that issued the request.
Example 22. The system of claim 21, further configured to: maintain access pattern data for the CPT entry in the CPT cache; and when the compressed page corresponding to the CPT entry is accessed while the CPT entry is in the CPT cache, update the access pattern data for the CPT entry.
Example 23. The system of any of claims 19-22, further configured to: allocate a compressible data structure for an application; create a virtual memory area (vma) to be used for the compressible data structure; divide the vma into a plurality of compressed memory regions (cmrs); create a cmr table containing respective cmr entries for each cmr; profiling access patterns to the compressed data by sampling access patterns to the compressed data to generate profiled access pattern data for respective cmrs.
Example 24. The system of claim 23, further configured to: maintain, in a cmr entry, indicia for a current compression scheme used for a cmr; determine, based on profile access pattern data for one or more pages in the cmr, a profiled compression scheme to be used for pages in the cmr; when the profiled compression scheme is different than the current compression scheme, recompressing pages in the cmr using the profiled compression scheme and updating the indicia corresponding to the current compression scheme in the cmr entry to correspond to the profiled compression scheme.
Example 25. The system of any of claims 19-24, wherein the compression schemes define chunk sizes used to store compressed data.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

The operations and functions performed by various components described herein may be implemented by embedded software/firmware running on a processing element, via embedded hardware or the like, or a combination of hardware and software/firmware. Such components may be implemented as software or firmware modules, hardware modules, special-purpose hardware (e.g., application specific hardware, ASICs, DSPs, etc.), embedded controllers, hardwired circuitry, hardware logic, etc. Software/firmware content (e.g., data, instructions, configuration information, etc.) may be provided via an article of manufacture including non-transitory computer-readable or machine-readable storage medium, which provides content that represents instructions that can be executed. The content may result in a computer or platform performing various functions/operations described herein.

As used herein, a list of items joined by the term “at least one of”′ can mean any combination of the listed terms. For example, the phrase “at least one of A, B or C” can mean A; B; C; A and B; A and C; B and C; or A, B and C.

The above description of illustrated embodiments, including what is described in the Abstract, is not intended to be exhaustive or to limit the claims to the precise forms disclosed. While specific embodiments of, and examples are described herein for illustrative purposes, various equivalent modifications are possible within the scope of the claims, as those skilled in the relevant art will recognize.

These modifications can be made in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method implemented on a computing platform including a processor having multiple cores and coupled to system memory comprising one or more memory devices and hosting an operating system, comprising:
storing respective data in the system memory as compressed data and uncompressed data;
profiling access patterns to the compressed data; and
determining, in view of the profiled access patterns, compression schemes to use to selectively recompress portions of the compressed data.

2. The method of claim 1, wherein profiling access patterns to the compressed data comprises sampling access patterns to the compressed data and generating access pattern data for respective regions of the compressed data.

3. The method of claim 1, further comprising:
in response to memory read request for a cache line issued by a core,
determining the cache line is stored in the compressed data;
fetching a compressed chunk of data containing the cache line;
decompressing, using hardware decompression, the compressed chunk of data to obtain decompressed data including the cache line; and
returning the cache line to the core that issued the request.

4. The method of claim 3, further comprising:
maintaining a compressed page table (CPT) comprising respective CPT entries for compressed pages;
identifying a CPT entry corresponding to a compressed page containing the compressed chunk of data containing the cache line; and
copying the CPT entry to a CPT cache.

5. The method of claim 4, further comprising:
maintaining access pattern data for the CPT entry in the CPT cache; and
when the compressed page corresponding to the CPT entry is accessed while the CPT entry is in the CPT cache, updating the access pattern data for the CPT entry.

6. The method of claim 5, further comprising:
copying the access pattern data and indicia from which the compressed page can be identified to a memory buffer; and
accessing, via the operating system, the access pattern data from the memory buffer.

7. The method of claim 1, further comprising:
allocating a compressible data structure for an application;
creating a virtual memory area (vma) to be used for the compressible data structure;
dividing the vma into a plurality of compressed memory regions (cmrs); and
creating a cmr table containing respective cmr entries for each cmr.

8. The method of claim 7, further comprising:
maintaining, in a cmr entry, indicia for a current compression scheme used for a cmr;
determining, based on profile access pattern data for one or more pages in the cmr, a profiled compression scheme to be used for pages in the cmr; and
when the profiled compression scheme is different than the current compression scheme, recompressing pages in the cmr using the profiled compression scheme and updating the indicia corresponding to the current compression scheme in the cmr entry to correspond to the profiled compression scheme.

9. The method of claim 7, further comprising maintaining mapping information that maps addresses for compressed pages to cmrs.

10. The method of claim 1, wherein the compression schemes define chunk sizes used to store compressed data in the compressed partition;
partitioning a physical address space for the system memory to include an uncompressed partition in which data are stored without compression and a compressed partition in which compressed data are stored.

11. A non-transitory machine-readable medium having instructions stored thereon configured to be executed on one or more cores of a multiple processor of a computing platform having multiple cores and coupled to system memory comprising one or more memory devices, wherein execution of the instructions enabled the computing platform to:
store respective data in the system memory as compressed data and uncompressed data;
access profiled access patterns to the compressed data; and
determine, in view of the profiled access patterns, compression schemes to use to selectively recompress portions of the compressed data.

12. The non-transitory machine-readable medium of claim 11, wherein execution of the instructions further enables the computing platform to:
allocate a compressible data structure for an application;
create a virtual memory area (vma) to be used for the compressible data structure;
divide the vma into a plurality of compressed memory regions (cmrs); and
create a cmr table containing respective cmr entries for each cmr.

13. The non-transitory machine-readable medium of claim 12, wherein execution of the instructions further enables the computing platform to:
maintain, in a cmr entry, indicia for a current compression scheme used for a cmr;
determine, based on profile access pattern data for one or more pages in the cmr, a profiled compression scheme to be used for pages in the cmr; and
when the profiled compression scheme is different than the current compression scheme, recompress pages in the cmr using the profiled compression scheme and update the indicia corresponding to the current compression scheme in the cmr entry to correspond to the profiled compression scheme.

14. The non-transitory machine-readable medium of claim 12, wherein execution of the instructions further enables the computing platform to maintain mapping information that maps addresses for compressed pages to cmrs.

15. The non-transitory machine-readable medium of claim 12, wherein execution of the instructions further enables the computing platform to partition a physical address space for the system memory to include an uncompressed partition in which data are stored without compression and a compressed partition in which compressed data are stored.

16. A system comprising:
system memory comprising a plurality of memory devices;
software comprising executable instructions associated with an operating system and processes for applications to be run on the operating system; and
a multi-core processor comprising,
multiple processor cores having associated level 1 (L1) and level 2 (L2) caches; and
a memory controller having an interface comprising one or more memory channels coupled to one or more of the plurality of memory devices;
wherein the system is configured to,
store respective data in the system memory as compressed data and uncompressed data;
profile access patterns to the compressed data in the compressed partition; and
determine, in view of the profiled access patterns, compression schemes to use to selectively recompress portions of the compressed data.

17. The system of claim 16, further configured to:
maintain a compressed page table (CPT) comprising respective CPT entries for compressed pages; and
in response to memory read request for a cache line issued by a core,
determine the cache line is in the compressed data;
identify a CPT entry corresponding to a compressed page containing a compressed chunk of data including the cache line; and
copy the CPT entry to a CPT cache.

18. The system of claim 17, further configured to:
fetch the compressed chunk of data including the cache line;
decompress, using hardware decompression, the compressed chunk of data to obtain decompressed data including the cache line; and
return the requested cache line to the core that issued the request.

19. The system of claim 17, further configured to:
maintain access pattern data for the CPT entry in the CPT cache; and
when the compressed page corresponding to the CPT entry is accessed while the CPT entry is in the CPT cache, update the access pattern data for the CPT entry.

20. The system of claim 16, further configured to:
allocate a compressible data structure for an application;
create a virtual memory area (vma) to be used for the compressible data structure;
divide the vma into a plurality of compressed memory regions (cmrs);
create a cmr table containing respective cmr entries for each cmr; and
profiling access patterns to the compressed data by sampling access patterns to the compressed data to generate profiled access pattern data for respective cmrs.
